(19) United States
(12) Patent Application Publication
(10) Pub. No.: US 2006/0017835 A1
(43) Pub. Date: Jan. 26, 2006

(54) Image compression region of interest selection based on focus information

(76) Inventor: Dana Jacobsen, Boise, ID (US)

Correspondence Address: HEWLETT-PACKARD COMPANY;Intellectual Property Administration, P.O. BOX 272400, Fort Collins, CO, 80527-2400, US

(21) Appl. No.: 11/184,008

(22) Filed: Jul. 22, 2004

(51) Int. Cl. H04N 5/232

(52) U.S. Cl. 348/345

(57) ABSTRACT

A method for compressing an image includes obtaining focus information generated when the image was captured, establishing a region of interest in the image based on the focus information, and identifying the region of interest to a compression algorithm. The method may also comprise assigning a first compression ratio to the image inside the region of interest and a second compression ratio to the image outside the region of interest, and compressing the image to the first compression ratio in the region of interest and to the second compression ratio outside the region of interest. In one exemplary embodiment, the focus information includes at least one focus point used by the electronic imaging device to focus when capturing the image.

### BACKGROUND

Electronic imaging devices such as digital cameras are used in a wide range of applications and are steadily becoming less expensive and simpler to use. Electronic images may be stored indefinitely without the image degradation suffered by film-based images. Electronic imaging devices generate images that can be viewed immediately and used in a variety of ways such as printing, posting to a web page on the World Wide Web, transmitting to others by electronic mail or other means, etc. They can also rapidly capture large numbers of images that can be previewed and stored or deleted as desired. However, storage capacity and bandwidth in electronic imaging devices and associated processing systems continue to be limiting factors on the number of electronic images that can be stored or transmitted. Although the capacity of removable solid-state memories for electronic imaging devices has increased, the resolution of electronic imaging devices has also increased. Uncompressed electronic image files therefore continue to be very large, placing a large burden on the storage capacity and bandwidth of electronic devices and associated processing systems such as personal computers and the Internet.

Electronic image files are often compressed to reduce their size, enabling many more images to be stored on a given electronic imaging device. The most frequently employed compression algorithms for electronic images are lossy algorithms such as the JPEG and JPEG2000 compression algorithms. Lossy compression algorithms typically result in much smaller files, but some data loss occurs during compression and expansion of the image. The quality of the electronic image is therefore degraded when the image is compressed with a lossy compression algorithm. The compression ratio of the compression algorithm may typically be configured within a wide range, either maximizing compression, producing a small compressed image file but increasing image degradation, or minimizing compression, producing a larger compressed image file but reducing image degradation.

Some compression algorithms, such as JPEG2000, include support for multiple compression levels in a single image file. A region of interest may be specified in the image, with a different compression ratio inside the region of interest than in the remainder of the image. For example, a region of interest may be identified in the image, typically corresponding to the subject of the image. The portion of the image outside the region of interest may be assigned a high compression ratio, reducing the file size, and the portion of the image inside the region of interest may be assigned a low compression ratio or no compression at all. This preserves the image quality of the subject, allowing the background in the image to be degraded more than the subject.

Multiple compression levels may also be achieved with other compression algorithms, such as JPEG, using techniques such as image segmenting. Although these compression algorithms do not include native support for multiple compression levels, an image may be divided into multiple smaller images, with different compression ratios used to compress the multiple smaller images. The resulting compressed images may be decompressed and pieced together to form the complete uncompressed image.

One difficulty in applying multiple compression levels in an electronic image is in identifying the region of interest or to otherwise identify portions of the image to receive the different compression ratios. A typical example of an application applying multiple compression levels is image editing software, which is used to generate electronic images. Different portions of the electronic images being generated may be drawn on different layers, with different compression ratios applied to the different layers. For example, the subject may be drawn on layer 1 and given light or no compression. The background may be drawn on layer 2 and given heavy compression. However, it is much more difficult to identify a subject or region of interest in a flat electronic image file, such as that captured by an electronic imaging device.

### SUMMARY

An exemplary embodiment may comprise a method for compressing an image, including obtaining focus information generated when the image was captured, establishing a region of interest in the image based on the focus information, and identifying the region of interest to a compression algorithm. The method may also include assigning a first compression ratio to the image inside the region of interest and a second compression ratio to the image outside the region of interest, and compressing the image to the first compression ratio in the region of interest and to the second compression ratio outside the region of interest. In one exemplary embodiment, the focus information includes at least one focus point used by the electronic imaging device to focus when capturing the image.

### BRIEF DESCRIPTION OF THE DRAWINGS

Illustrative embodiments are shown in the accompanying drawings as described below.

FIG. 1 is an isometric front view illustration of an exemplary electronic imaging device.

FIG. 2 is an isometric rear view illustration of the exemplary electronic imaging device of FIG. 1.

FIG. 3 is a block diagram of an exemplary embodiment of an electronic imaging device.

FIG. 4 shows an exemplary focus point and a region of interest overlaid on a simulated image.

FIG. 5 shows an exemplary group of focus points and a region of interest overlaid on a simulated image.

FIG. 6 shows an exemplary group of focus points and a region of interest overlaid on a simulated image, where the region of interest is made up of multiple disjoint regions.

FIG. 7 shows an exemplary region of interest overlaid on a simulated image, where the region of interest is generated based on focus information other than a focus point.

FIG. 8 is a flow chart of an exemplary operation for applying multi-level compression to an electronic image based on focus information.

FIG. 9 is a block diagram of an exemplary embodiment of an electronic imaging device including computer readable program code for selecting a region of interest based on focus information.

### DESCRIPTION

The drawing and description, in general, disclose a method and apparatus for selecting a region of interest in an electronic image based on focus information, and for compressing the region of interest in the image at a different level of compression than the remaining regions in the image. The term “region of interest” is used herein to refer to a portion of an electronic image that is to be compressed at a different compression ratio than other portions of the electronic image or to be otherwise given emphasis or preference by a compression algorithm. The region of interest may be a single area, having any shape, or may be a group of separate, or disjoint, areas in the image. For example, the region of interest may correspond generally to the subject in an image, with little to no compression applied to the region of interest and more compression applied outside the region of interest. Image degradation due to lossy compression is therefore minimized around the subject. The heavier compression outside the region of interest results in a smaller image file, while the increased image degradation outside the region of interest is less important because it is in the background. Background elements in images are often less sharply focused if they fall outside the depth of field, so image degradation is less likely to be noticed.

In one exemplary embodiment, an electronic imaging device such as a digital camera is used to capture the image, and the image is compressed with a lossy compression algorithm by the electronic imaging device with multiple levels of compression based on focus information. For example, the region of interest in one exemplary embodiment is selected based on focus points in the electronic imaging device.

In alternative embodiments, the compression algorithm may give preference or emphasis to the region of interest in other ways. For example, the compression algorithm may move the region of interest to the front of the compressed bitstream, so that given a slow medium or viewing software, the region of interest will appear first. This also protects the region of interest if the compressed bitstream must be truncated or more heavily compressed if bandwidth for the bitstream is exhausted or reduced, effectively giving the region of interest a different compression ratio with higher quality than the remainder of the image.

The focus point is the location or locations in the frame of the electronic imaging device at which a focus condition is detected during a focus operation. For example, some digital cameras allow manual selection of a focus point. The photographer then overlays this focus point on the region that should be in best focus, such as the eye of the main subject. The digital camera detects the focus condition at this point, ensuring that the eye of the subject is most sharply focused in the image. Other digital cameras include a large number of focus points that are used to identify the subject of the image. In one exemplary embodiment, the digital camera establishes a region of interest based on the focus point or points, and compresses the region of interest less than the rest of the image, thereby minimizing file size while maintaining the image quality of the subject.

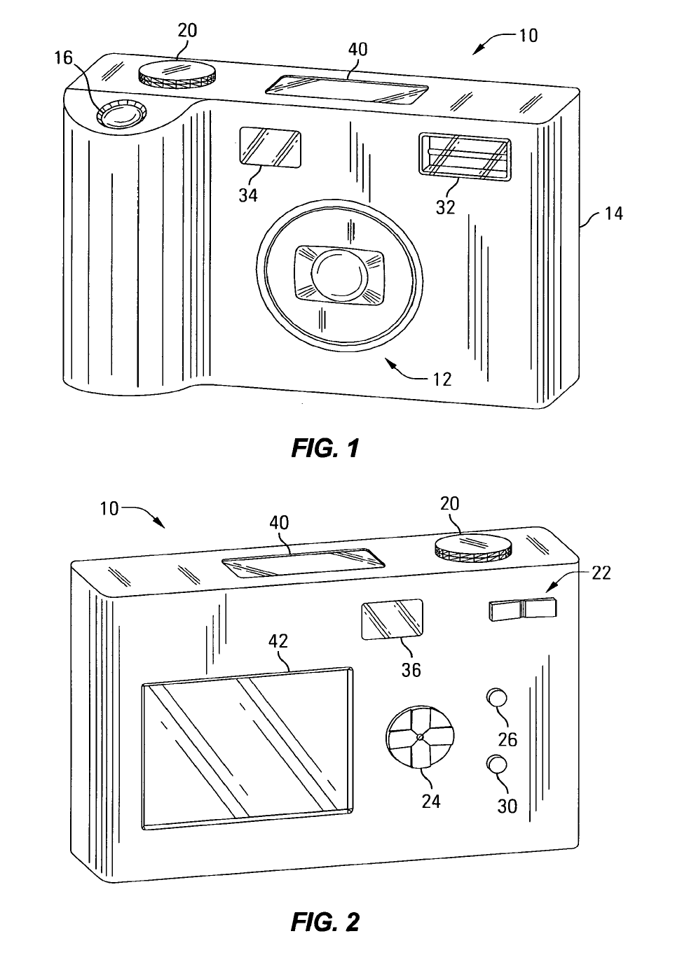

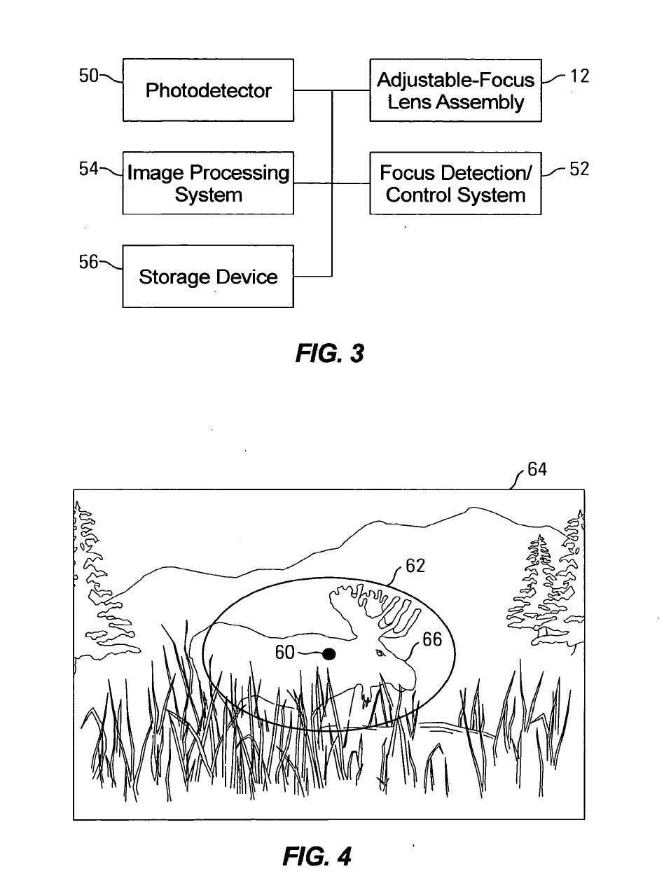

Before continuing to describe the region of interest selection in more detail, an exemplary digital camera 10 (FIGS. 1-3) which may employ multiple levels of compression based on focus information will be described. However, it is important to note that the multi-level compression of an image based on focus information is not limited to any particular type of electronic imaging device, and the digital camera 10 discussed herein is purely exemplary. The digital camera 10 comprises a housing portion or body 14 which is sized to receive the various systems and components required by the digital camera 10. For example, in the embodiment shown and described herein, the body 14 is sized to receive a photodetector 50, a lens assembly 12, a focus detection/control system 52, an image processing system 54 to process and format the image data, and a storage device 56 to store the image data collected by the photodetector 50. The lens assembly 12 is located in the body 14 to allow light to enter the digital camera 10. The body 14 may also be sized to receive a power source such as a battery. Control buttons such as a shutter control button 16, a mode dial 20, a zoom control switch 22, and others (e.g., 24, 26, and 30) as needed are provided on the outside of the body 14. The exemplary digital camera 10 includes an illumination system such as a flash 32 mounted on the outside of the body 14. Viewfinder windows 34 and 36 and display devices 40 and 42 are also located on the outside of the body 14. Each of the foregoing systems and devices will now be described.

Image light enters the digital camera 10 through the lens assembly 12. The photodetector 50, a charge-coupled device (CCD) or other image sensor, detects the image light focused thereon by the lens assembly 12. A typical CCD comprises an array of individual cells or pixels, each of which collects or builds-up an electrical charge in response to exposure to light. Because the quantity of the accumulated electrical charge in any given cell or pixel is related to the intensity and duration of the light exposure, a CCD may be used to detect light and dark spots in an image focused thereon.

The term image light as used herein refers to the light, visible or otherwise, that is focused onto the surface of the photodetector 50 by the lens assembly 12. The image light may be converted into digital signals in essentially three steps. First, each pixel in the CCD detector converts the light it receives into an electric charge. Second, the charges from the pixels are converted into analog voltages by an analog amplifier. Finally, the analog voltages are digitized by an analog-to-digital (A/D) converter, generating numeric representations of the amplitudes of the analog voltages. The digital data then may be processed and/or stored as desired.

A focus detection/control system 52 is located in the body of the digital camera 10 to detect a focus condition or aid the photographer in detecting a focus condition. As will be discussed below, a region of interest based on focus information may be used in a compression algorithm either in the electronic imaging device or later in another electronic device, and the region of interest may be based on focus information generated by any suitable type of focus system. Therefore, the method and apparatus for selecting a region of interest in an electronic image is not limited to use with any particular type of electronic imaging device or focus system. For example, the focus system in the digital camera 10 may comprise an automatic focusing system, either passive or active, or a manual focusing system such as that commonly used in a manual focus single-lens reflex (SLR) camera.

Several examples of suitable focus systems will be described generally. Various passive focus systems exist, such as a contrast detection system or a phase detection system. An electronic imaging device using a passive contrast detection focus system monitors the scene as the lens is driven back and forth, comparing the difference in intensity between adjacent pixels until a focus position is found giving the maximum intensity difference between adjacent pixels. One or more focus points may be used, comparing intensity differences for pixels within the focus points. An electronic imaging device using a passive phase detection focus system works in principle like the split-image focusing aid found in many manual focus SLR cameras. Image light is split by one or more lenses or prisms so that each half of the split-image is directed onto two lines of a photodetector array. The intensities detected by each pixel in the lines, when graphed, form a wave shape whose peaks and valleys correspond to light and dark values. The focus system compares these waveforms formed by the two lines of the photodetector array for the two split-image halves. If the peaks and valleys do not line up and are out of phase, the image is not focused at that location. The direction and distance of the phase displacement indicate the direction and magnitude of focus adjustment needed. If multiple focus points are used, the light-splitting component is included for each focus point. The imaging photodetector may be used for focusing, or one or more other focusing photodetectors. An exemplary passive phase detection focus system and a focus system that determines a direction and magnitude of needed focus adjustment are described in U.S. Pat. No. 4,786,933, entitled “Focus detection apparatus for camera”, and U.S. Pat. No. 4,333,007, entitled “Method and apparatus for determining focus direction and amount”, which are incorporated herein by reference for all that they disclose.

An electronic imaging device using an active focus system emits a signal such as a pulse of infrared light, then detects the reflected signal, and calculates the distance from the subject based on the time it took the pulse to return. Multiple focus points may be used if desired by transmitting multiple aimed signals.

A manual focus system may also be used, as long as the focus system gathers information about the focus condition for one or more focus points.

The focus system may store just an indication of the focus points and their focused state, or may store additional information that may be used by the compression algorithm. For example, the passive phase detection focus system described above may store an indication of how far out of focus each focus point is, and in what direction. A continuous tone region of interest may be generated based on this information, so the compression algorithm can use a multitude of compression ratios, smoothly increasing quality in the image areas where focus improves. Other focus systems include logic for handling panning or moving subjects, and information generated by this logic may be stored for use in generating the region of interest.

The exemplary focus systems discussed above may be used to provide focus information for use in generating a region of interest for a compression algorithm. However, the method and apparatus for selecting a region of interest in an electronic image based on focus information, and for compressing the region of interest in the image at a different level of compression than the remaining regions in the image, is not limited to any particular type of electronic imaging device or focusing system, as long as some focus information is available to configure the multi-level compression algorithm. Depending upon the information provided by the focus system, the compression algorithm may tailor the image processing in different ways, varying from basic compression of the region of interest at a lower compression ratio than the rest of the image, to a continuous tone compression discussed above in which a greater number of compression ratios are used to smoothly transition between the region of interest and the rest of the image, etc. The region of interest may be used by a compression algorithm in any way now known or that may be developed in the future. As mentioned above, one exemplary compression algorithm may move image data for the region of interest to the front of the data stream for the image. Other compression algorithms may use the region of interest based on focus information in other ways to enhance image quality.

An image processing system 54 is located in the body 14 of the digital camera 10 to process and format the image data, either before or after storage in the storage device 56. The image processing system 54 comprises a microprocessor and associated memory. Alternatively, the image processing system 54 may comprise a hard-coded device such as an application specific integrated circuit (ASIC). The image processing system 54 obtains focus information from the focus detection/compression system 52 and compresses images with multiple levels of compression based on the focus information. The image processing system 54 may use any suitable compression algorithm, and any suitable method of applying multiple compression levels to different regions of an image, as long as the regions are selected based on the focus information. In one exemplary embodiment, the image processing system 54 configures a region of interest in a compression algorithm having native support for multiple levels of compression, such as JPEG2000, so that the region of interest is compressed at a different level than other regions. In another exemplary embodiment, the image processing system 54 divides an image into multiple segments and applies different levels of compression to the image segments using other compression algorithms, such as JPEG. The image processing system 54 may also process image data to scale images for display on a graphical display device 42, among other tasks. A storage device 56 is located in the body 14 of the digital camera 10 to store the image data collected by the photodetector 50. The storage device 56 comprises a removable rewriteable non-volatile memory, or may comprise a random access memory (RAM), or a magnetic, optical, or other solid state storage medium.

The graphical display device 42 comprises a liquid crystal display (LCD) or any other suitable display device. An alphanumeric display device 40 on the digital camera 10 also comprises an LCD or any other suitable display device, and is used to indicate status information, such as the number of images which can be captured and stored in the storage device, and the current mode of the digital camera 10.

The digital camera 10 may also include other components, such as an audio system. However, because digital cameras are well-known in the art and could be provided by persons having ordinary skill in the art after having become familiar with the teachings of the present disclosure, the digital camera 10 utilized in one embodiment, as well as the various ancillary systems and devices (e.g., battery systems and storage devices) that may be utilized in one embodiment will not be described in further detail herein.

During operation of the digital camera 10, the digital camera 10 is turned on and off by one of the control buttons such as the mode dial 20. The digital camera 10 is oriented with the lens assembly 12 directed at a subject. The subject may be monitored either through a viewfinder 34 and 36, or on the graphical display panel 42. A focus point in the viewfinder 34 and 36 is directed at a subject, an object in the field of view which is to be brought into focus, and focus lens elements in the lens assembly 12 are adjusted to focus image light from the subject onto the photodetector 50. When the digital camera 10 is properly oriented and focused, the shutter control button 16 is pressed. The flash 32 illuminates the subject, if needed. The photodetector 50 then converts the image light directed thereon by the lens assembly 12 into electrical image data. The image processing system 54 then processes the image data, displays the captured image on the display device 42, compresses the image data using multiple compression levels based on the focus information, and stores the compressed image data in one or more files on the storage device 56.

The selection of a region of interest in an image will now be described in more detail. Once a region of interest is selected, a compression algorithm may be applied to the image, with a lower compression ratio inside the region of interest than outside it. Referring now to FIG. 4, a first exemplary embodiment includes a singe focus point 60 that is used to select a region of interest 62 in an electronic image 64. The focus point 60 is placed on a subject 66 during image composition, and the electronic imaging device (or the photographer, given a manual focus system) ensures that the image is correctly focused at the focus point 60. The region of interest 62 is selected automatically in the electronic imaging device based on the location of the focus point 60. For example, the region of interest 62 may comprise a predetermined shape which is positioned in the image so as to center the focus point 60 in the region of interest 62.

In this embodiment, the subject 66 is not identified as such in the image 64, so the region of interest 62 may or may not correspond with the subject 66. For example, the exemplary region of interest 62 overlaps the subject 66, a moose, but does not completely encompass it. Furthermore, the region of interest 62 includes some background around the subject 66. Although this exemplary embodiment does not identify subjects 66 as such, and therefore the region of interest 62 may not correspond directly to a subject 66, this exemplary embodiment provides an extremely fast and simple way of identifying a region of interest 62 around a focus point 60. This enables a simple and inexpensive electronic imaging device to quickly apply a lower compression ratio to the region of interest 62 around a focus point 60, maintaining image quality in the region of interest 62, while applying a higher compression ratio to other areas in the image to reduce the file size.

Although the exemplary region of interest 62 is drawn as an oval, oriented so the long axis is parallel with the long axis of the image 64, any shape may be used. For example, a rectangular region of interest may result in the simplest application in the JPEG2000 and other compression algorithms, resulting in faster compression times. Other shapes may be employed as desired. For example, the region of interest in some compression algorithms such as the JPEG2000 algorithm may be specified as a bitmap mask, so the region of interest may be made up of any shape or collection of pixels in the image, either contiguous or disjoint.

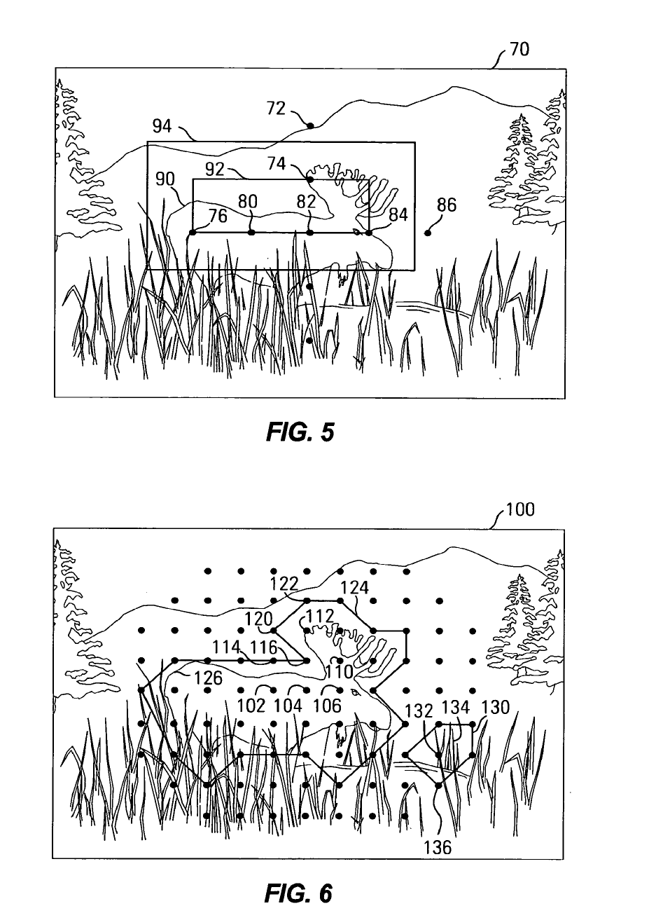

In an alternative embodiment, multiple focus points may be used to focus an image. Referring now to FIG. 5, a total of 9 focus points (e.g., 72, 74, 76, 80, 82, 84 and 86) are used by an electronic imaging device to focus when capturing an image 70. As is well known, the focus is detected at one or more of the 9 focus points 72-86 in an attempt to properly focus the subject 90. Some focus points (e.g., 72 and 86) may not rest on the subject 90, while others 74, 76, 80, 82 and 84 do. As a result, the electronic imaging device may detect that the focus points 74, 76, 80, 82 and 84 placed on the subject 90 are in focus, while others (e.g., 72 and 86) are not. The region of interest is selected based on the 9 focus points 72-86. In this exemplary embodiment, the region of interest is selected by identifying the focus points 74, 76, 80, 82 and 84 that are focused, and enclosing them in some shape to be used as the region of interest. For example, a rectangle 92 may be formed using the focused focus points 74, 76, 80, 82 and 84 as boundaries, then expanded a predetermined amount to form a larger rectangle 94 that is likely to enclose a subject 90. This larger rectangle 94 is used as the region of interest, and is compressed at a lower compression ratio, or no compression at all, while the portion of the image 70 outside the region of interest is more heavily compressed to reduce file size. Another suitable way of arriving at this result is to pre-establish a fixed size and shape 94 for the region of interest in whatever device will apply the multi-level compression, and to center it about the focus points 74, 76, 80, 82 and 84 that are focused when the image is captured.

In another alternative embodiment (see FIG. 6), an electronic imaging device uses a large number of focus points (e.g., 102, 104, 106, 110, 112, 114, 116, 120, 122, 132 and 136) in any suitable manner, including presently known algorithms, to focus an image 100 during capture. In this example, 87 focus points are used, so some (e.g., 102-112) may fall on a subject 126, while others (e.g., 114-122, 132 and 136) fall outside the subject 126 in the image 100. In this exemplary embodiment, the region of interest is formed based on the focus points (e.g., 102-122, 132 and 136). Polygons may be formed around focus points or groups of focus points that are in focus, with the polygons used as the region of interest. For example, a group of focus points (e.g., 102, 104, 106, 110 and 112) may be identified that are in focus, and a polygon 124 may be traced along the focus points (e.g., 114, 116, 120 and 122) that are not focused around the focused group (e.g., 102, 104, 106, 110 and 112). This process is continued until a closed polygon 124 is formed for inclusion in the region of interest.

The region of interest is not limited to one contiguous area 124, and may include other areas (e.g., 130), if other focus points (e.g., 132) are on an object (e.g., 134) which is in focus. A polygon 130 is again formed by tracing unfocused focus points (e.g., 136) around a group of focused focus points (e.g., 132). Thus, the region of interest may include multiple discrete areas in the image 100.

The region of interest may be selected based on the focus points in this exemplary embodiment in any suitable manner, such as the focus-point tracing described above. An alternative method would be to include in the region of interest an area around each focused focus point (e.g., 132). The areas to include around each focused focus point may have a predetermined shape and size, established so that the areas around neighboring focused focus points would meet to form a single larger area. Other methods may be used as appropriate to form the region of interest, as long as it is based on focus information generated when the image is captured by the electronic imaging device.

As discussed above, the selection of a region of interest based on focus information for use in multi-level compression of an image may be adapted to both active focusing and passive focusing techniques. Active focusing involves transmitting energy in some form, such as infrared light, from the electronic imaging device onto a focus object, and receiving reflections from the focus object to determine the distance from the imaging device to the focus object. The lens system in the electronic imaging device can then be set to the proper focus position according to that distance. Passive focusing involves capturing consecutive images while adjusting the lens system in the electronic imaging device and comparing the images to determine when the electronic imaging device is properly focused. For example, a digital camera using passive focusing may search for the focus position that results in the maximum intensity difference between adjacent pixels in an image.

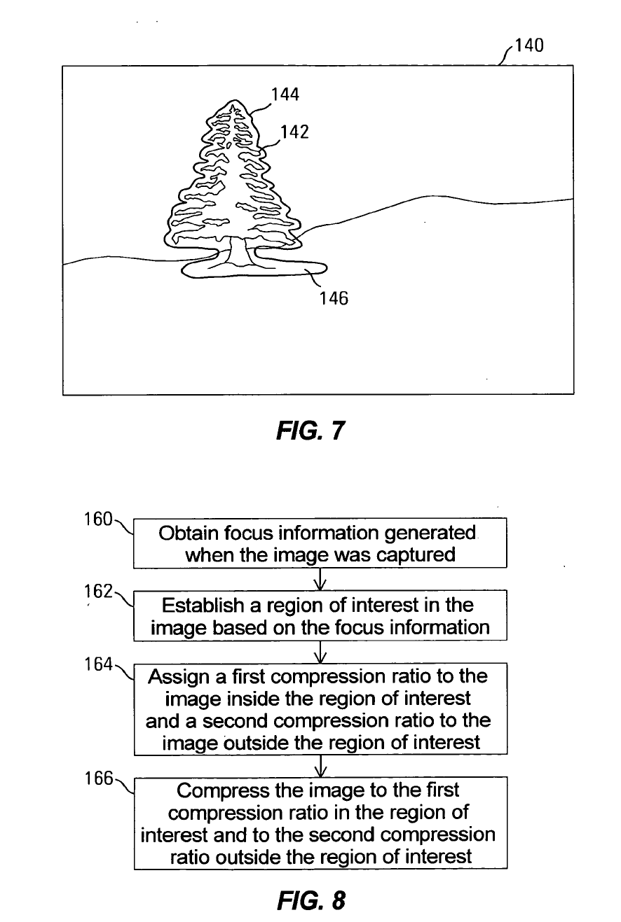

An exemplary embodiment adapted for use with passive focusing is illustrated in FIG. 7. The focus object 142 or location in the frame to be focused may be identified in any suitable manner, including techniques now known. For example, a focus point (not shown) or other tool may be used to identify the subject 142 to be focused in an image 140. The focus algorithm proceeds normally until the focus object 142 is properly focused, as well as any other portions of the image 140 that are at the same focal distance. For example, in the simulated image 140 of FIG. 7, assuming the depth of field is large enough, the entire tree 142 will be focused, as well as portions 146 of the landscape that fall within the depth of field. Focus information identifying the focused area, generated when the image 140 is captured, is obtained, and the focused area is used as the region of interest 144 or is enclosed in the region of interest 144. The region of interest 144 may be expanded to extend slightly beyond the focused portion of the image 140 to ensure that the subject is enclosed in the region of interest 144. A lower compression ratio may then be applied to the region of interest 144 than to the remainder of the image 140, in any manner suitable to the chosen compression algorithm. For example, if using the JPEG2000 algorithm, the region of interest may be specified in the algorithm as a bitmap mask corresponding to the region of interest 144. The image quality of the focused region is thus preserved, while the unfocused regions are more highly compressed to minimize file size. The image degradation resulting from the higher compression outside the region of interest 144 will not be as noticeable in the image 140 because the image 140 was already somewhat unfocused in those areas.

The multi-level compression of an image based on focus information may take place either inside the electronic imaging device used to capture an image, or outside the electronic imaging device in another device, such as a personal computer. For example, focus information may be stored with the image and transferred to another device. In this embodiment, the entire image may be stored uncompressed or lightly compressed in the electronic imaging device, then transferred to another device. The other device may use the focus information stored in the image file to apply the multi-level compression to reduce the file size. Focus information may be stored in any suitable manner, such as being embedded in the image file as metadata, as described in the EXIF specification, the Digital Still Camera Image File Format Standard (Exchangeable image file format for Digital Still Cameras: Exif) Version 2.1, Jun. 12, 1998, Japan Electronic Industry Development Association. Alternatively, focus information may be stored outside of the image file with a link or pointer between the image file and a focus information file, or in a database configured to associate focus information with image files, etc.

In summary, the selection of a region of interest for multi-level compression may be based directly on the focus points, or indirectly by using the focus points to identify the subject of an image, or on other focus information such as the regions determined to be in focus. An exemplary operation for multi-level image compression based on focus information is illustrated in FIG. 8. The device applying the compression, whether the electronic imaging device that captured the image or some other device, obtains 160 the focus information generated when the image was captured and establishes 162 a region of interest in the image based on the focus information. The device assigns 164 a first compression ratio to the image inside the region of interest and a second compression ratio to the image outside the region of interest, and compresses 166 the image to the first compression ratio in the region of interest and to the second compression ratio outside the region of interest, using any suitable compression algorithm.

An exemplary application of multi-level compression based on focus information is in a digital camera used by a sports photographer. A very fast frame rate, such as 8 frames per second, may be used, with the multi-level compression minimizing the image file size without degrading the images unacceptably. The small file size facilitates large bursts of data, storage of many images on a memory card, and fast transmission.

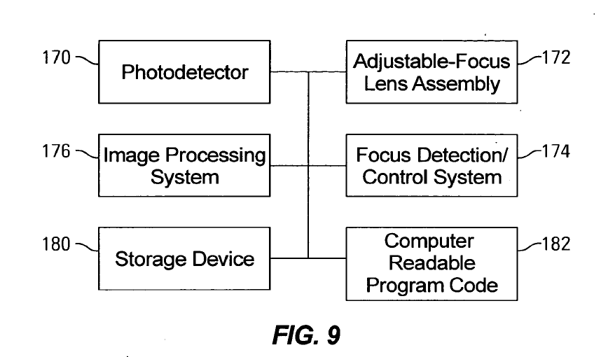

An exemplary embodiment of multi-level compression based on focus information may comprise computer readable program code stored on at least one computer readable medium for execution either in an electronic imaging device or other device. For example, an exemplary electronic imaging device is illustrated in FIG. 9, including a photodetector 170, a lens assembly 172, a focus detection/control system 174, an image processing system 176, a storage device 180, and computer readable program code 182 stored in any suitable manner, such as a read-only memory (ROM). The exemplary computer readable program code includes code for identifying at least one focus point used to focus the electronic image when the electronic image was captured, program code for identifying a region of interest in the electronic image based on the at least one focus point, and program code for compressing the electronic image. The region of interest in the electronic image is compressed less than a region of the electronic image outside the region of interest.

Various computer readable or executable code or electronically executable instructions have been referred to herein. These may be implemented in any suitable manner, such as software, firmware, hard-wired electronic circuits, or as the programming in a gate array, etc. Software may be programmed in any programming language, such as machine language, assembly language, or high-level languages such as C or C++. The computer programs may be interpreted or compiled.

Computer readable or executable code or electronically executable instructions may be tangibly embodied on any computer-readable storage medium or in any electronic circuitry for use by or in connection with any instruction-executing device, such as a general purpose processor, software emulator, application-specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly embodying computer readable or executable code or electronically executable instructions includes any means that can store, transmit, communicate, or in any way propagate the code or instructions for use by or in connection with the instruction-executing device. For example, the storage medium may include (but is not limited to) any electronic, magnetic, optical, or other storage device, or any transmission medium such as an electrical conductor, an electromagnetic, optical, infrared transmission, etc. The storage medium may even comprise an electronic circuit, with the code or instructions represented by the design of the electronic circuit. Specific examples include magnetic or optical disks, both fixed and removable, semiconductor memory devices such as memory cards and read-only memories (ROMs), including programmable and erasable ROMs, non-volatile memories (NVMs), optical fibers, etc. Storage media for tangibly embodying code or instructions also include printed media such as computer printouts on paper which may be optically scanned to retrieve the code or instructions, which may in turn be parsed, compiled, assembled, stored and executed by an instruction-executing device. The code or instructions may also be tangibly embodied as an electrical signal in a transmission medium such as the Internet or other types of networks, both wired and wireless.

While illustrative embodiments have been described in detail herein, it is to be understood that the concepts disclosed herein may be otherwise variously embodied and employed, and that the appended claims are intended to be construed to include such variations, except as limited by the prior art.

What is claimed is:

1. A method for compressing an image, comprising:
obtaining focus information generated when said image was captured;
establishing a region of interest in said image based on said focus information; and
identifying said region of interest in said image to a compression system.

2. The method of claim 1, wherein said focus information comprises information about a least one focus point used by an electronic imaging device to focus when capturing said image, and wherein said region of interest is established based on said at least one focus point.

3. The method of claim 1, wherein said focus information comprises information identifying focused portions of said image and unfocused portions of said image, and wherein said region of interest corresponds to said focused portions of said image.

4. The method of claim 1, further comprising:
assigning a first compression ratio to said image inside said region of interest and a second compression ratio to said image outside said region of interest; and
compressing said image to said first compression ratio in said region of interest and to said second compression ratio outside said region of interest.

5. The method of claim 4, wherein said second compression ratio is higher than said first compression ratio.

6. The method of claim 4, wherein said compressing said image is performed using a lossy compression algorithm.

7. The method of claim 6, said lossy compression algorithm comprising the JPEG2000 compression algorithm.

8. The method of claim 6, said lossy compression algorithm comprising the JPEG compression algorithm.

9. The method of claim 8, further comprising segmenting said image into a plurality of sub-images, wherein said compressing said image to said first compression ratio in said region of interest comprises compressing said sub-images corresponding to said region of interest to said first compression ratio, and wherein said compressing said image to said second compression ratio outside said region of interest comprises compressing said sub-images not corresponding to said region of interest to said second compression ratio.

10. The method of claim 1, wherein said method is performed in an electronic imaging device.

11. A digital camera, comprising:
a focus system; and
an image processing system connected to said focus system in said digital camera to receive focus information for said digital camera, wherein said image processing system is adapted to compress an image with a plurality of compression ratios based on said focus system.

12. The digital camera of claim 11, wherein said focus information comprises information identifying focused portions of said image and unfocused portions of said image, and wherein said unfocused portions of said image are more highly compressed than said unfocused portions of said image.

13. The digital camera of claim 11, wherein said focus system comprises at least one focus point.

14. The digital camera of claim 13, wherein said image processing system is adapted to identify at least one region of interest in said image based on said at least one focus point and to compress said at least one region of interest with a different compression ratio than a remainder of said image outside said region of interest.

15. The digital camera of claim 13, said at least one focus point comprising at least one location in a frame of said digital camera at which a focused condition is detected by said focus system.

16. The digital camera of claim 11, wherein said focus system comprises an autofocus system.

17. The digital camera of claim 11, wherein said focus system comprises a manual focus system.

18. An apparatus for compressing an electronic image, comprising:
a. at least one computer readable medium; and
b. computer readable program code stored on said at least one computer readable medium, said computer readable program code comprising:
i. program code for identifying at least one focus point used to focus said electronic image when said electronic image was captured;
ii. program code for identifying a region of interest in said electronic image, said region of interest containing said at least one focus point; and
iii. program code for compressing said electronic image, wherein said region of interest in said electronic image is compressed less than a region of said electronic image outside said region of interest.

19. The apparatus of claim 18, wherein said program code for compressing said electronic image comprises program code for compressing said electronic image using the JPEG2000 compression algorithm.

20. The apparatus of claim 18, wherein said at least one focus point comprises a single focus point, and wherein said program code for identifying said region of interest comprises program code for identifying an area within a predetermined distance of said single focus point.

21. The apparatus of claim 18, wherein said at least one focus point comprises a plurality of focus points, and wherein said program code for identifying said region of interest comprises program code for identifying an area surrounding said plurality of focus points.

22. The apparatus of claim 21, wherein said area is bounded by at least some of said plurality of focus points.

23. The apparatus of claim 18, further comprising program code for segmenting said electronic image into a plurality of sections based on said region of interest, wherein said program code for compressing said electronic image comprises program code for compressing said plurality of sections with at least two different compression ratios using the JPEG compression algorithm.

24. An imaging device, comprising:
means for focusing an image at least one focus point in a frame in said imaging device;
means for capturing said image;
means for identifying at least one region of interest in said image based on said at least one focus point; and
means for compressing said image wherein a first compression ratio is achieved in said region of interest and a second compression ratio is achieved in said image outside said region of interest.
